(19) United States
(12) Patent Application Publication
(10) Pub. No.: US 2020/0196075 A1
(43) Pub. Date: Jun. 18, 2020

(54) MANUFACTURING METHOD FOR A HEARING DEVICE AND HEARING DEVICE

(71) Applicant: SIVANTOS PTE. LTD, SINGAPUR (SG)

(72) Inventors: RUBAN SUNDARA RAJ THASAPPARAJ, Selem tamil Nadu (IN); Zainal Abidin Bin Mohd Yahya, Singapore (SG)

(21) Appl. No.: 16/713,316

(22) Filed: Dec. 13, 2019

(30) Foreign Application Priority Data
Dec. 13, 2018 (DE) 102018221696

(51) Int. Cl. H04R 25/00

(52) U.S. Cl. CPC H04R 25/658; H04R 25/652; H04R 2225/021; H04R 25/602; H04R 25/609

(57) ABSTRACT

A manufacturing method for a hearing device, in particular for a hearing aid device, includes preassembling at least one signal processor and at least one microphone in a predetermined position spatially fixed in relation to one another to form an electronic base module. The electronic base module is subsequently inserted into a plastic molding tool and positioned and held in the plastic molding tool by using at least one structural element of the electronic base module, which is in contact with the surroundings in an intended final manufacturing state. Plastic is then introduced into the plastic molding tool to form a main housing for the electronic base module, in which the electronic base module is embedded. A sound channel is kept free for a fluidic connection of the microphone to the surroundings. A hearing device is also provided.

### CROSS-REFERENCE TO RELATED APPLICATION

This application claims the priority, under 35 U.S.C. § 119, of German Patent Application DE 10 2018 221 696, filed Dec. 13, 2018; the prior application is herewith incorporated by reference in its entirety.

### BACKGROUND OF THE INVENTION

### Field of the Invention

The invention relates to a manufacturing method for a hearing device. The invention furthermore relates to a hearing device, preferably one which is produced by using the manufacturing method.

A hearing device is typically used for outputting acoustic signals at the ear of a wearer of the hearing device. For that purpose, such a hearing device typically includes an output transducer, which is usually constructed as a loudspeaker (also referred to as a “receiver”). The output transducer is typically enclosed by a housing part of the hearing device, for example, a housing shell or the like, to protect the output transducer from environmental influences and/or to enable an intended alignment of the output transducer, for example, in the auditory canal of the wearer of the hearing device. Such a hearing device can, for example, be a headset, headphones, so-called (in-ear) wearables, hearables, tinnitus maskers, or the like.

However, hearing devices are frequently also used for supplying persons having reduced hearing ability by way of (frequently wearer-specific) amplified and/or filtered acoustic signals to at least partially compensate for the existing hearing loss. In that case, such a hearing device is also referred to as a hearing aid device or hearing aid for short. In particular, in the case of a hearing aid, the hearing device typically also includes an input transducer, usually in the form of a microphone for acquiring ambient noises and also a downstream signal processor (also referred to as a “controller”) for processing (filtering and/or amplifying) signals generated from the ambient noise and for outputting those processed signals at the output transducer. In the case of hearing aids, the output transducer can additionally also—depending on the type of the hearing loss—be constructed as a bone conduction receiver or cochlear implant for mechanical and/or electrical stimulation of the hearing of the wearer.

Furthermore, different structural forms are also used in hearing aids. In the case of so-called behind-the-ear hearing aids (abbreviated as “BTE”), the at least one microphone, the signal processor, and a power source are disposed in a housing (part) to be worn behind the pinna. The output transducer can also be disposed in that housing (part) in that case and is connected in that case in the intended wearing state to the auditory canal of the wearer by using a sound tube. Alternatively, the loudspeaker can also be disposed in a separate housing part (often referred to as an “earpiece”) and can be connected through a signal line to the components disposed in the actual hearing aid housing. Furthermore, so-called in-the-ear hearing aids (abbreviated as “ITE”) are also used, which include a housing to be worn entirely or partially in the auditory canal and containing the electronic components.

In order to enable the advantage of the supply with correspondingly processed signals in every circumstance in life, i.e., also, for example, during sports, for the wearer of the hearing device, in particular the hearing aid, hearing aids have increasingly also been developed with the most liquid-tight housings possible. The penetration of, for example, sweat or water (for example, during swimming or showering, in the rain, etc.) is to be prevented thereby. Since power sources, specifically batteries, have to be replaced frequently, a seal of the corresponding openings in the housing of the hearing device requires a comparatively high level of effort. Therefore, housings are also already known which are formed from the fewest possible individual parts.

### SUMMARY OF THE INVENTION

It is accordingly an object of the invention to provide a manufacturing method for a hearing device and a hearing device, which overcome the hereinafore-mentioned disadvantages of the heretofore-known methods and devices of this general type and which provide a hearing device having an improved housing.

With the foregoing and other objects in view there is provided, in accordance with the invention, a manufacturing method for a hearing device, in particular for a hearing aid device, which comprises:
at least one signal processor and at least one microphone preassembled in a predetermined position are spatially fixed in relation to one another to form an electronic base module,
the electronic base module is inserted into a plastic molding tool and positioned and held in the plastic molding tool by using at least one structural element of the electronic base module, which is in contact with the surroundings in an intended final manufacturing state, and
plastic is introduced into the plastic molding tool to form a main housing for the electronic base module, in which the electronic base module is embedded, whereas a sound channel is kept free for the fluidic connection of the microphone to the surroundings.

The manufacturing method according to the invention is used for producing a hearing device, which is preferably a hearing aid device, referred to for short as a “hearing aid.” The hearing device which is also according to the invention includes at least one signal processor and at least one microphone, in particular for acquiring airborne noise from the surroundings of a user of the hearing device.

According to the method, in particular the signal processor and the at least one microphone are firstly preassembled in a predetermined position spatially fixed in relation to one another to form an electronic base module. The electronic base module is then inserted into a plastic molding tool (“tool” for short) and positioned and held in the tool by using at least one structural element of the electronic base module, which is in contact with the surroundings in the intended final manufacturing state. The electronic base module is preferably aligned (also referred to as “centering”) by using this structural element in relation to the tool, preferably in the corresponding cavity of the tool. Subsequently, plastic is introduced into the tool to form a preferably media-tight main housing for the electronic base module. The electronic base module is embedded in this plastic at the same time. A sound channel for the fluidic connection of the microphone to the surroundings is kept free in this case.

The term “main housing” is understood in this case and below in particular to mean that this housing or this housing part, respectively, encloses a majority of the structural volume occupied by the hearing device, preferably by the electronic base module. The main housing is preferably formed in this case by an injection step of the plastic and thus monolithically. The main housing is optionally formed by multiple injection steps, which are controlled in processing in such a way, however, that the different components of the main housing are materially bonded to one another.

The electronic base module is preferably also provided with further electronic components. Optionally, for example, analog-to-digital converters are connected between the respective microphone and the signal processor, components for voltage stabilization of a supply voltage from a power source are provided, and conductor tracks are laid for signal transmission between the individual components.

Since the electronic base module is embedded in the plastic of the main housing, the hearing device can advantageously also be formed comparatively compactly, since gaps do not have to be maintained for installing the electronic base module in a separately manufactured housing. Furthermore, a comparatively high level of media-tightness (in particular water-tightness) can be enabled. In addition, manufacturing time can also be saved. Furthermore—in particular for the case in which the main housing is manufactured in only one injection step—manufacturing effort, in particular effort during the planning and production of the tool, can be saved since the tool can be constructed comparatively simply and nonetheless at least nearly complete embedding of the electronic base module, in any case at least the components to be housed, is enabled in only one injection step.

In one expedient method variant, a microphone cover is connected to the electronic base module in particular before the embedding of the electronic base module in the plastic. This microphone cover houses the microphone in relation to the surroundings in this case in an intended final manufacturing state of the hearing device. The sound channel to be kept free extends in this case (already preformed) through the microphone cover. The microphone cover therefore represents, in particular jointly with the electronic base module, an insert part (also referred to as an “insert”), so that the formation of the sound channel does not have to take place in the injection step during the forming of the main housing itself.

The microphone cover is preferably attached to the main housing by the embedding in the plastic in a materially bonded manner and thus as media-tight as possible.

In one preferred method variant, the above-described microphone cover, at least its sound channel, is used as a structural element for holding and positioning the electronic base module in the tool. The microphone cover forms, for example, a type of end cap of the hearing device, under which at least the membrane of the or the respective microphone is exposed toward the internal end of the (respective, correspondingly associated) sound channel. In this case, the tool, in particular its cavity, has a complementary groove, in which the microphone cover is suitably inserted—while positioning the entire electronic base module. Additionally or alternatively, the tool includes at least one protruding pin, which plunges into the sound channel upon insertion of the electronic base module having the microphone cover fastened thereon, seals it against penetration of plastic, and holds the electronic base module positioned in the cavity.

In a further expedient method variant, charging contacts disposed on the electronic base module for a rechargeable battery of the hearing device are used as a structural element for holding and positioning the electronic base module in the tool—additionally or alternatively to the above-described microphone cover. The hearing device therefore includes such charging contacts which are already disposed during the installation on the electronic base module and are preferably fastened in such a way—for example, soldered on—that they can be used as a holder for the electronic base module (possibly in cooperation with the microphone cover). The charging contacts preferably have a central region in this case, which is enclosed in a ring-like manner by an edge. This edge is formed to be protruding or recessed in relation to the central region in the direction of the surroundings in this case. The charging contacts are thus preferably formed to be convex or concave as viewed in cross section, so that they—in the convex variant—are used for plugging into a corresponding recess in the tool or—in the concave variant—for plugging onto a pin or the like, which protrudes on the tool. The edge has in this case both a holding function and also a centering function. The charging contacts are preferably formed rotationally symmetrical.

In one preferred method variant, which is also expediently combined with the usage of the charging contacts as a structural element, a rechargeable battery, which is used for the power supply of at least the signal processor, is connected to the electronic base module. This rechargeable battery is also electrically coupled to the signal processor in this case. The rechargeable battery is preferably also coupled to the above-described charging contacts—possibly indirectly through a charging electronic unit. The rechargeable battery in this case is accordingly also embedded in the plastic jointly with the electronic base module (which includes the charging electronic unit preferably provided in this case). A high level of integration of the manufacturing process is thus enabled, in particular an assembly which is self-contained as much as possible for the hearing device. Manufacturing costs and/or assembly effort can thus be saved.

In one advantageous method variant, thermoplastic is introduced into the plastic molding tool as the plastic by using injection molding. This enables a high throughput in the case of mass production and also a comparatively high level of structural freedom for the main housing.

In particular, for the case in which injection molding is used as the injection process, in one preferred method variant, the rechargeable battery is enclosed before the embedding in the plastic using an in particular thermally insulating insulation material—for example, a film, a suitable gel, or the like. (Thermal) damage to the rechargeable battery due to the plastic melt injected at or above its melting temperature can thus be prevented.

In a further expedient method variant, in which the hearing device is preferably manufactured for the connection of an external loudspeaker (for example, as a so-called “receiver in canal” hearing aid), a terminal port (in particular a plug terminal) for at least electrical (preferably also mechanical) coupling of the external loudspeaker to the signal processor (and/or the electronic base module or the main housing) is used as a structural element for holding and positioning the electronic base module in the tool. The electronic base module preferably has a recess in this case, in which a corresponding plug can engage for the coupling of the external loudspeaker. A displaceably constructed element (also referred to as a “gate”) of the tool expediently engages in this recess upon the insertion of the electronic base module and is in contact with the electronic base module to hold and position it.

In one preferred method variant, the signal processor and the at least one microphone and also possibly the charging contacts are positioned and disposed in relation to one another on a carrier part to form the electronic base module. The carrier part is, for example, a component assuming solely mechanical functions—for example, a “frame” formed from a metal or plastic—on which a printed circuit board (PCB) is disposed, an, in particular three-dimensionally formed, printed circuit board, or a combination thereof.

In one conceivable variant in the scope of the invention, assembly injection molding is used as the injection molding method, by which a detachable connection between the main housing and the microphone cover is enabled. For example, incompatible plastics are used in this case, which do not form a material bond during the embedding, or a suitable temperature control is selected in the tool, which prevents the microphone cover from being heated enough by the inflowing melt that a material bond is formed.

With the objects of the invention in view, there is concomitantly provided a hearing device, comprising:
an electronic base module, which includes a signal processor and at least one microphone, which are installed in a predetermined position spatially fixed in relation to one another,
a main housing manufactured in one piece from plastic, in which the electronic base module is embedded while keeping free a sound channel for the fluidic connection of the microphone to the surroundings, and
in particular, the hearing device is manufactured according to the manufacturing method of the invention.

The hearing device according to the invention, in particular the hearing aid, also includes in addition to the above-described electronic base module having the signal processor and the at least one microphone, which are assembled in a predetermined position spatially fixed in relation to one another, the main housing manufactured in one piece from plastic, in which the electronic base module is embedded while keeping free the sound channel for the fluidic connection of the microphone to the surroundings. In particular, the hearing device according to the invention is manufactured according to the above-described manufacturing method and therefore has corresponding advantages.

“Material bonding” or a “material bond” between at least two parts connected to one another is understood in this case and below in particular to mean that the parts connected to one another are held together on the contact surfaces thereof by material unification or cross-linking (for example, because of atomic or molecular bonding forces), possibly with the action of an additive.

The conjunction “and/or” is to be understood in this case and below in particular to mean that the features linked by using this conjunction can be formed both jointly and also as alternatives to one another.

Other features which are considered as characteristic for the invention are set forth in the appended claims.

Although the invention is illustrated and described herein as embodied in a manufacturing method for a hearing device and a hearing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a hearing device;

FIG. 2 is a perspective view of a support frame for electronic components of the hearing device;

FIG. 3 is a perspective view according to FIG. 1 of an electronic base module formed by using the support frame and electronic components fastened thereon;

FIG. 4 is a perspective view of a microphone cover for the electronic base module;

FIG. 5 is a perspective view according to FIG. 1 of the electronic base module having the installed microphone cover;

FIG. 6 is a perspective view of the hearing device in an intermediate manufacturing step;

FIGS. 7 and 8 are perspective views of structural elements of the electronic base module, which are used for holding the electronic base module in a plastic molding tool; and

FIG. 9 is a diagrammatic, perspective view of a tool half of the plastic molding tool in an opened state.

### DETAILED DESCRIPTION OF THE INVENTION

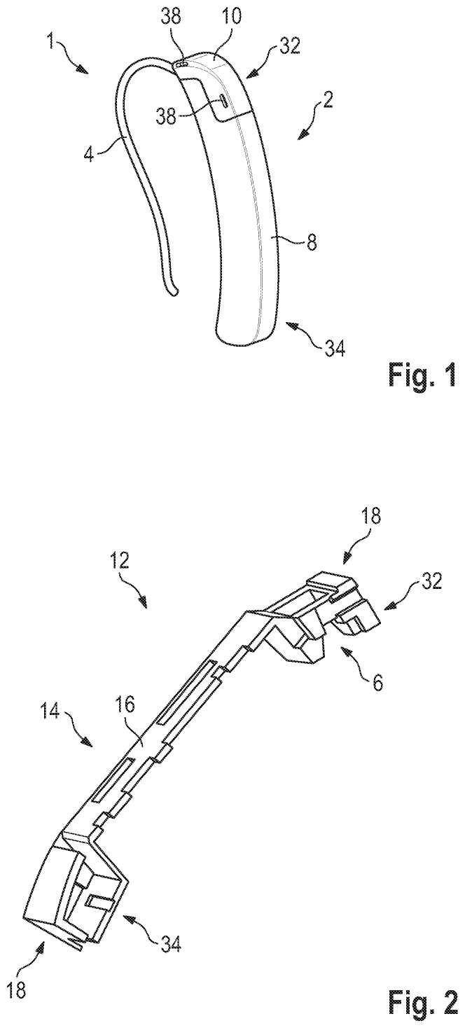

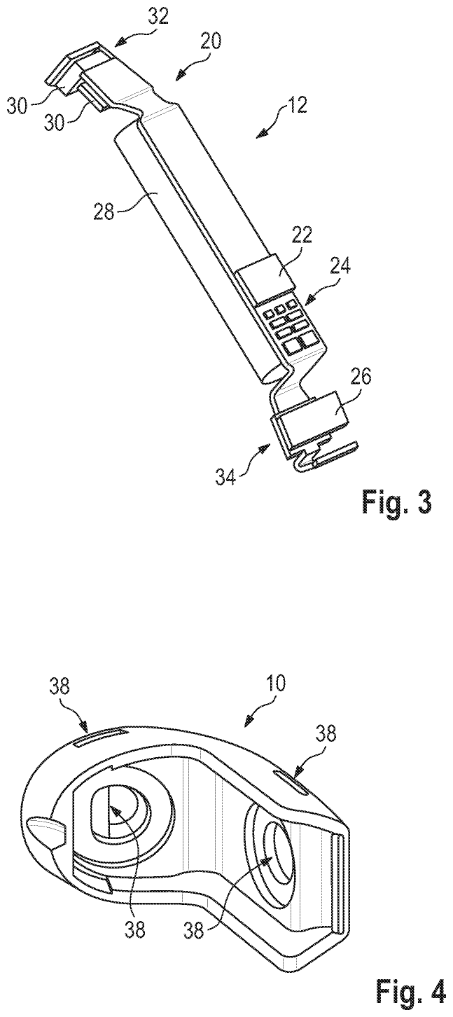

Referring now in detail to the figures of the drawings, in which parts corresponding to one another are always provided with identical reference signs, and first, particularly, to FIG. 1 thereof, there is seen a hearing device, abbreviated as “hearing aid 1.” The hearing aid 1 specifically forms a so-called “behind-the-ear hearing aid.” The hearing aid 1 therefore includes a base body 2, which contains electronic components of the hearing aid 1 and is to be worn behind the ear of a user of the hearing aid 1. Furthermore, the hearing aid 1 includes a receiver connection device 4, with the aid of which a relay of acoustic output signals of the hearing aid 1 to an ear, specifically into the auditory canal of the user of the hearing aid 1 is possible. In the present exemplary embodiment, the receiver connection device 4 is a receiver connection cable of an external loudspeaker (not shown in greater detail), which is disposed in the auditory canal of the user in the intended wearing state of the hearing aid 1. The receiver connection device 4 is embodied so that it can be reversibly coupled to the base body 2 in this case and in the intended coupled state (see FIG. 1) it is coupled in a terminal port 6 (described in greater detail below and seen in FIG. 6) to the base body 2.

The base body 2 includes a main housing 8 (described in greater detail below) and a microphone cover 10 produced separately therefrom. The base body 2 includes an electronic base module 12 in the interior of the main housing 8. This module in turn has a carrier frame 14, which is formed by a pre-bent and stamped sheet-metal strip 16 having extruded plastic end pieces 18 (see FIG. 2). Moreover, the electronic base module 12 includes a pre-bent circuit carrier 20 equipped with electronic components, specifically formed by a three-dimensionally formed printed circuit board.

The electronic base module 12 and thus also the hearing aid 1 includes electronic components, namely a signal processor 22, a number of further electronic components 24 (for example, transistors, transducers, and the like), and a charging electronic unit 26 for a rechargeable battery 28 which is also disposed on the electronic base module 12. Moreover, the electronic base module 12 includes two microphones 30, which are embodied in this case as MEMS components. These two microphones 30 are disposed in this case at a first end 32 of the electronic base module 12 and/or the hearing aid 1. Multiple, specifically four charging contacts 36 for charging the rechargeable battery 28 are disposed at a second end 34 of the electronic base module 12, in the region of which the charging electronic unit 26 is disposed, opposite to the first end 32. They are connected through the charging electronic unit 26 to the battery 28.

The microphone cover 10 forms an “end cap” disposed at the first end 32, which protects the microphone 30 from mechanical influences. Two sound channels 38 are incorporated into the microphone cover 10 for the fluidic connection of the microphone 30 to the surroundings, and thus so that airborne noise can penetrate to the microphones 30.

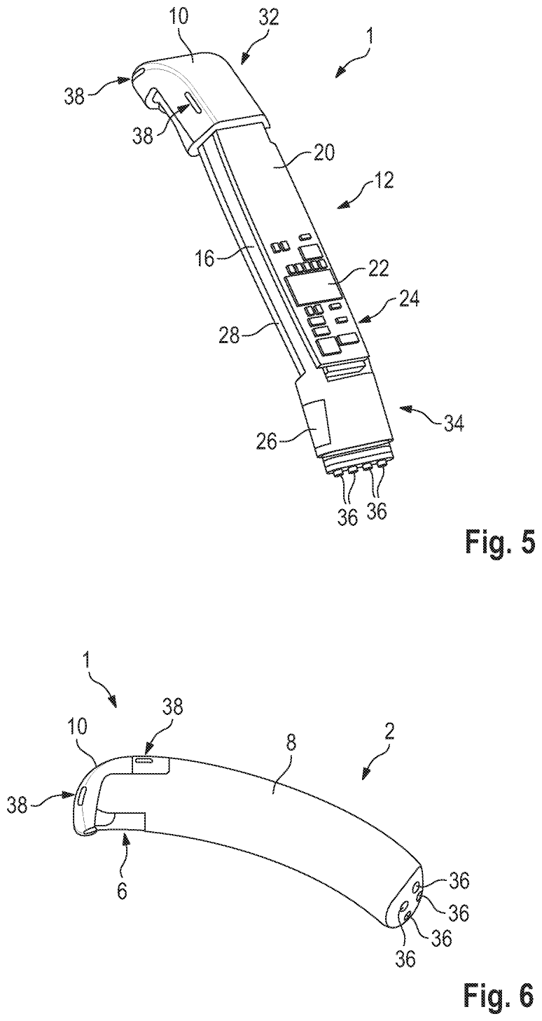

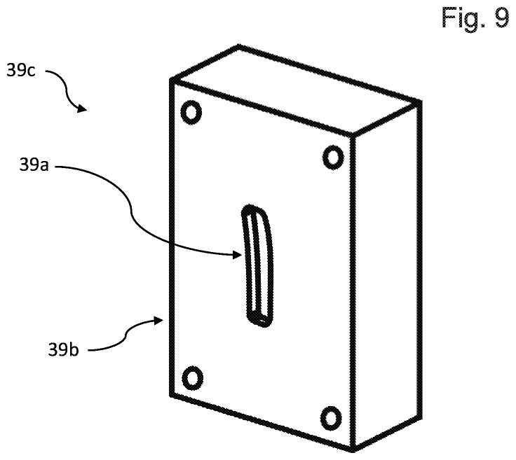

The electronic base module 12 is illustrated in the intended assembled state in FIG. 5. The electronic base module 12 in this case forms a preassembled unit of the hearing aid 1. The circuit carrier 20 is plugged together with the carrier frame 14 in this case. The microphone cover 10 is additionally plugged or alternatively adhesively bonded on the first end 32, specifically on the end piece 18 thereon. The electronic base module 12 is inserted after the assembly in a cavity 39a of a plastic molding tool (FIG. 9 shows only a part, which is also referred to as a “tool half 39b,” of the plastic molding tool), specifically an injection molding tool, which is referred to as “tool 39c” for short. Subsequently, the electronic base module 12 is extrusion coated using plastic, and therefore embedded in this plastic, to form the main housing 8. The sound channels 38 are kept open or free in this case, i.e., are not filled with plastic. Specifically, the microphone cover 10 is not covered by the injected plastic.

Structural elements of the electronic base module 12 are used in a manner described in greater detail below for holding and positioning (also “centering”) the electronic base module 12 in the tool 39c, specifically its cavity 39a.

In one exemplary embodiment, the microphone cover 10 is used as such a structural element. The electronic base module 12 is inserted in this case with the microphone cover 10 into a complementary recess of the cavity. In this case, the recess is dimensioned in such a way that, on one hand, plastic is prevented from flowing around the microphone cover 10 in the injection molding process and, on the other hand, mechanical fixing of the electronic base module 12 is enabled. Optionally, fixed or displaceable tool elements (so-called “gates”) engage in the sound channels 38 for additional sealing and holding in this case.

In a further (additional or alternative) exemplary embodiment, the terminal port 6 is used as a structural element for holding and positioning the electronic base module 12. The terminal port 6 includes a recess formed in one of the end pieces 18, in which or on which a mechanical catch device for fixing the receiver connection device 4 and electrical terminal contacts for contacting the receiver connection device (and thus the external loudspeaker) are disposed (not shown in greater detail). Specifically, in this exemplary embodiment, an (optional further) gate of the tool 39c engages in the terminal port 6 and results in holding, positioning, and sealing of the terminal contacts and catch elements of the terminal port 6 against plastic flowing around them in this case.

In addition to the use of the microphone cover 10 as a structural element, it enables comparatively stable holding and positioning of the electronic base module 12 jointly with the gate engaging in the terminal port 6.

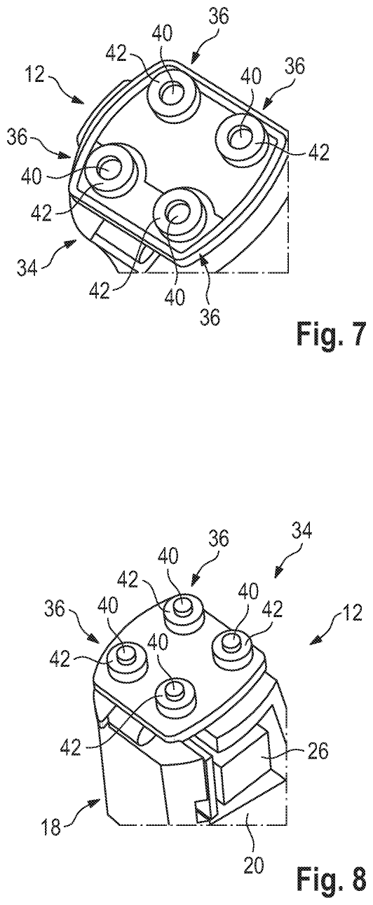

In a further (optional additional or alternative) exemplary embodiment, the charging contacts 36, which are exposed to the surroundings in the intended partially assembled state of the hearing aid 1 (see FIG. 6) are used as a structural element for holding and positioning. In order to enable a certain form-locking with the tool 39c, in this case each of the charging contacts 36 includes a central region 40, which is enclosed in a ring shape by an edge 42. The edge 42 is embodied to be offset relative to the central region 40 in this case. In one variant illustrated in FIG. 7, the edge 42 protrudes toward the surroundings in relation to the central region 40. In contrast, in an alternative variant (see FIG. 8), the edge 42 is recessed in relation to the central region 40 (the central region 40 thus protrudes toward the surroundings). In the variant according to FIG. 7, the charging contacts 36 are plugged onto complementary pins of the tool 39c, while in contrast the charging contacts 36 according to FIG. 8 are plugged into complementary recesses (boreholes) of the tool 39c.

In an optional exemplary embodiment, the charging contacts 36, the terminal port 6 and also the microphone cover 10 are used for holding and positioning.

In a further exemplary embodiment, the rechargeable battery 28 is enveloped by an insulation film (not shown) for thermal insulation against the heat of the injected plastic before the insertion into the tool 39c, in particular during the installation of the electronic base module 12.

The subject matter of the invention is not restricted to the above-described exemplary embodiments. Rather, further embodiments of the invention can be derived by a person skilled in the art from the above description. In particular, the individual features of the invention described on the basis of the various exemplary embodiments and the structural variants thereof can also be combined with one another in another way.

### LIST OF REFERENCE SIGNS

1 hearing aid
2 base body
4 receiver connection device
6 terminal port
8 main housing
10 microphone cover
12 electronic base module
14 carrier frame
16 sheet-metal strip
18 end piece
20 circuit carrier
22 signal processor
24 electronic components
26 charging electronic unit
28 battery
30 microphone
32 first end
34 second end
36 charging contact
38 sound channel
39a cavity
39b tool half
39c plastic molding tool
40 central region
42 edge

1. A manufacturing method for a hearing device or a hearing aid device, the method comprising the following steps:
preassembling at least one signal processor and at least one microphone in a predetermined position spatially fixed in relation to one another to form an electronic base module;
inserting the electronic base module into a plastic molding tool and positioning and holding the electronic base module in the plastic molding tool by using at least one structural element of the electronic base module being in contact with the surroundings in an intended final manufacturing state; and
introducing plastic into the plastic molding tool to form a main housing for the electronic base module in which the electronic base module is embedded, while keeping a sound channel free for a fluidic connection of the at least one microphone to the surroundings.

2. The manufacturing method according to claim 1, which further comprises connecting the electronic base module to a microphone cover housing the at least one microphone in relation to the surroundings in the intended final manufacturing state of the hearing device, and extending the sound channel through the microphone cover.

3. The manufacturing method according to claim 2, which further comprises using the microphone cover or at least the sound channel as the at least one structural element for holding and positioning the electronic base module.

4. The manufacturing method according to claim 1, which further comprises:
using charging contacts disposed on the electronic base module for charging a rechargeable battery of the hearing device as the at least one structural element for holding and positioning the electronic base module;
the charging contacts including an edge enclosing a central region in a ring-shaped manner and protruding or being recessed in relation to the central region in a direction of the surroundings.

5. The manufacturing method according to claim 1, which further comprises connecting a rechargeable battery for a power supply of at least the signal processor to the electronic base module, electrically coupling the rechargeable battery to the signal processor and embedding the rechargeable battery jointly with the electronic base module in the plastic.

6. The manufacturing method according to claim 1, which further comprises introducing thermoplastic into the plastic molding tool as the plastic by injection molding.

7. The manufacturing method according to claim 5, which further comprises:
introducing thermoplastic into the plastic molding tool as the plastic by injection molding; and
enclosing the rechargeable battery by using an insulation material before embedding in the plastic.

8. The manufacturing method according to claim 1, which further comprises using a terminal port for at least an electrical coupling of an external loudspeaker to the at least one signal processor as the at least one structural element for holding and positioning the electronic base module.

9. The manufacturing method according to claim 8, which further comprises placing a displaceably formed element of the plastic molding tool in contact with the terminal port for holding and positioning.

10. The manufacturing method according to claim 1, which further comprises positioning and placing the at least one signal processor and the at least one microphone in relation to one another on a carrier part to form the electronic base module.

11. The manufacturing method according to claim 10, which further comprises additionally positioning and placing charging contacts for charging a rechargeable battery of the hearing device in relation to the at least one signal processor and the at least one microphone on the carrier part to form the electronic base module.

12. A hearing device, comprising:
an electronic base module including a signal processor and at least one microphone being installed in a predetermined position spatially fixed in relation to one another;
a main housing manufactured in one piece from plastic, said electronic base module being embedded in said main housing; and
a sound channel being kept free for a fluidic connection of said at least one microphone to the surroundings.
